(19) United States
(12) Patent Application Publication
(10) Pub. No.: US 2009/0228716 A1
(43) Pub. Date: Sep. 10, 2009

(54) METHOD AND SYSTEM FOR DISTRIBUTED COORDINATION OF ACCESS TO DIGITAL FILES

(75) Inventors: Timothy POSTON, Karnataka (IN); Tomer SHALIT, Holmsund (SE); Mark DIXON, Skarholmen (SE)

Correspondence Address: NIXON & VANDERHYE, PC, 901 NORTH GLEBE ROAD, 11TH FLOOR, ARLINGTON, VA, 22203, US

(73) Assignee: PADO METAWSRE AB, Umea (SE)

(21) Appl. No.: 12/366,418

(22) Filed: Feb. 5, 2009

Related U.S. Application Data
(60) Provisional application No. 61/027,042, filed on Feb. 8, 2008.

(51) Int. Cl. G06F 17/30; G06F 12/14

(52) U.S. Cl. 713/189; 707/203; 707/10; 707/E17.01; 707/E17.032

(57) ABSTRACT

The invention enables a user to create a saved Version of a file which gives (besides the usual content access and format specifications) information in a Wrapper which permits it to be transferred while maintaining a provenance relationship with other files and cryptographic relation with a server. Data in the Wrapper may include content location, Collaboration identity, provenance data, a site location for provenance data, data concerning necessary harmonisation, cryptographic or password data, data enabling the recipient to join a web service supporting the Collaboration, and other such data enabling web-supported interaction with the content. Upon opening the Version the user sees and can modify or re-transmit the content in a display that makes use of the Wrapper information to enable and organize access to the content, to the provenance information and related files, or other web-enabled interaction with the content and the Collaboration.

### CROSS REFERENCE TO RELATED APPLICATION

This application claims the benefit of Provisional Application No. 61/027,042 filed on Feb. 8, 2008, incorporated herein by reference in its entirety.

### TECHNICAL FIELD

The invention relates to collaboration from a number of users on a single digital file.

### BACKGROUND

It is a frequent task for a group of people to collaborate on a single digital file, whether this file represents a document, a computer program, a video, a computer-aided design for a building or device, a battle strategy, a plan for a complex surgical procedure, or any other such entity. Throughout this application we refer for illustrative purposes to a ‘document’ and to the typical user as an ‘author’, without prejudice to the inclusion of all other types of digital file to which our discussion naturally applies, and the modification is by a ‘programmer’, a ‘planner, a ‘designer’, a ‘general’, a ‘surgeon’, or any other such term for an agent modifying a digital file in collaboration with other agents.

FIG. 1 (reproduced from Poston, Shalit and Dixon, “A Method and System for Facilitating the Production of Documents”, USPTO application number 60884230, Jan. 10, 2007, herein incorporated by reference) shows a common scenario of current co-authorship in practice, with a time-line from left to right. One author creates a first draft 100, and sends it around to the other people whose name will be on the document. Two of these people begin work on it, and circulate their versions 101 and 102. Another author (perhaps that of version 101, perhaps a fourth user) reads these versions and absorbs those of their changes she likes into a new file 104, with her own additions and deletions. Meanwhile, yet another author has created file 103 from the original file 100, with changes that are not in files 101, 102 or 104. Some other author who has already contributed, or has not, simultaneously uses 101, 102 and 103 to create file 105. Two distinct authors then independently use 104 and 105 to create distinct conflations 106 and 107, with—once again—their own distinct additions. Faced with all these versions, it is not easy to be sure in a new version that all useful changes have been collated, or to do the collation.

Today's common systems of ‘version control’ address the problems of collation, but leave room for improvement. Our USPTO application number 60884230, Jan. 10, 2007, cited above, describes means of handling such histories as FIG. 1, aiding the selection of which versions to collate. Poston, Shalit, Dixon, and Westerberg, “A Method and System for Harmonization of Variants of a Sequential File” (USPTO Application 20080313243-A1, Dec. 18, 2008) describes a unified interface for collation of the selected versions. (These applications are hereby incorporated by reference.) We do not revisit these collation problems here, but note the common contrast of our solutions with extant methods, that our solutions do not require that authors lock in to a common, corporate document handling system. They may belong to different companies or institutions, use different editing software, different operating systems, and so on. The need for such flexibility arises when users in different companies and law firms are discussing a contract, when scientific collaborators around the world are preparing a technical paper, and whenever users find it difficult—as most users do—to adapt to the requirements of a rigid control system. Enabling such flexibility involves certain problems, a key one of which we address here.

A centralized version control system typically includes a centralized file server. In some cases (particularly those prioritizing institutional security) a version file never as a unit leaves that central server: an author sees only a window displaying the part of the file currently being modified, through editing software whose interface runs over a network. In other cases the file or a portion of it may be downloaded to the author's machine, and even worked on off-line with locally resident software, but the centralization remains central to the user experience. Often a file (or a section of it) is ‘checked out’ by one author: to avoid—rather than solve—synchronization problems, no other author may change it until it is ‘checked in’ by the first. A joint project will typically develop multiple versions of a file, and even multiple related but distinct files, such as a video sequence, a script for it, a print-publication version of the material, a mission statement, a critique, and so on. In a web service such as Google Documents these files appear in a specific folder, and may be sorted into subfolders, following a sorting scheme that all authors must follow. One sorting scheme, encouraged for local files by both Windows and Mac operating systems, divides up files first according to broad types such as Music, Movies, Documents, etc. An author who has succumbed to this encouragement is likely to be uncomfortable with a scheme that sorts the files of an opera by putting music and libretto together in folders structured by Act and Scene, or by the performance in which versions were historically used: if all authors apply their own habits to the shared web folder, chaos ensues. For such a system, somehow, the group must agree on a sorting scheme, Sometimes such an agreed and enforced structure is useful, but in general it can hamper the development of on-the-fly collaboration to have to consult and agree on such a superstructure at the start, and a structure that grows haphazardly by individual author decisions is likely to be a ramshackle impediment to work. Similarly, if central software does not systematize version naming, it is often according to multifarious schemes: an author A will edit a received version fubar.doc of a document and upload the result or mail it around under the identical name, another author B will edit, save and distribute it as fubarB.doc or myfubar.doc, or as futar05_{—}04.doc (read by US collaborators as referring to May 4^{th}, by Europeans as 5^{th} April), with endless variability. The provenance-handling scheme disclosed in the above-cited “A Method and System for Digital File Flow Management” leaves authors free to follow such habits without enforcing them on others, at no expense in confusion. However, the exemplary embodiments there discussed retained the assumption that files are stored on a central server, and uploaded and downloaded between that server and an individual client, with various forms of notification and update. This may seem less than natural to a user who took some years to master email and a further interval to learn to include a file as an attachment: having mastered this exoteric but novel skill, such user resists switching to another mental model of file sharing.

Central storage offers the user certain advantages such as inherent off-site backup of files, which may further be reinforced by physically distributed backup of the server, but it is not the only framework in which the above-cited inventions may be applied. Furthermore, confidential collaborators may not wish to store their files in a place where an unresisted subpoena or bribe may expose them to a competitor or other opponent. If a central server runs the comparison methods disclosed in the above-cited applications, by which provenance is established and by which conflicting changes are detected and presented to the user for harmonization, it necessarily has the capability to read the files through whatever encryption is in use. (Current schemes cannot combine the use of an encryption key known only to the user and the user's collaborators with flexible sharing of that key and low-user-effort synchronization.) Moreover, even a free storage site may shift its business model to start charging for space, file for bankruptcy, be acquired by an entity hostile to the user's purposes, or otherwise cause a user to regret that storage was outsourced. If the entire project was stored by a single out-sourced storage provider, the files of the participants are not available as back-up.

We therefore disclose below a method and system for distributed coordination of file versions saved by users on systems that they separately control, such as a local disk, and on space in a remote server to which they subscribe, removable memory, and so forth, and in which unencrypted forms need only exist on the users' own computers. For brevity, we refer to all such means of saving as ‘personal’, in that they are separately controlled by each user, and do not automatically grant access to other users in the distributed synchronization system. In the disclosed system, central storage is optional. A user may send a saved file to another as an e-mail attachment (by any preferred email software, not only by a required office program of which the synchronization system must be an integral part, and in which the user must establish an address) in the same way as files outside a synchronization system, as though no central server is involved in the traffic. One user may save personal copies and versions in a manner sorted by project, while another user in the same collaborative project may save them in a manner sorted by type of content, and a further user sorts by copyright ownership, by a provenance-based register of files, by disk address, by a multi-viewpoint system such as that disclosed in Poston, Raghavan, Fenton and Poston, Search and presentation engine, U.S. Pat. No. 7,080,059, or M Hearst, Design Recommendations for Hierarchical Faceted Search Interfaces, in the ACM SIGIR Workshop on Faceted Search, August, 2006, by creation date, by acquisition number, or by such other filing and retrieval system as may suit the user's purposes, and so on for further users, without restriction. The present invention is not sensitive to such variation of user choice.

We note that since local saving normally requires (for security reasons) locally installed software beyond a browser, no system for synchronization of the saved files can currently operate as a completely web-based ‘software as a service’ solution.

### SUMMARY

The invention enables a user to create from a file a saved Version which not only gives access to the user content (such as text, image, plans, melodies, etc.), and directions to an application that opens it on how it shall be presented to the user (such as typeface, color table for image decompression, etc.), but information in a Wrapper which permits it to be mailed, moved to a different folder or otherwise transferred while maintaining a provenance relationship with other files. Access to the user content may be provided either by its direct inclusion the Version, or providing data as to where it may automatically be obtained via a net. Additional data in the Wrapper may include any of, but are not limited to: content location; the identity of a Collaboration of which the Version is a part; provenance data concerning other files from which the Version may be partly derived or which are relevant to it; the location of an often up-dated site which maintains provenance data, data concerning alternate Versions or other files with which the Version may be harmonized; cryptographic or password data, in preferred embodiments to be used in coordination with a web server, enabling access by the intended collaborators but unavailable to others; data enabling the recipient to join a web service supporting the Collaboration, and thereby to initiate other Collaborations; and other such data enabling web-supported interaction with the content.

Upon opening the Version by the use of an application, a rich internet application (RIA), a site providing server-side software, or otherwise, the user sees and can in most embodiments modify or re-transmit the content in a display that makes use of the Wrapper information, by decrypting or otherwise enabling access, by showing the participants in the Collaboration and its history, and by displaying other files which the current Version's content should be harmonised according to automated analysis of its provenance or to the same or another user's judgement that it is relevant. In our preferred embodiment the display of such other files is integrated in a structured window, but display in separate windows is within the ambit of the present invention.

The invention enables a user to create a saved Version of a file which gives (besides the usual content access and format specifications) information in a Wrapper which permits it to be transferred while maintaining a provenance relationship with other files and cryptographic relation with a server. Data in the Wrapper may include content location, Collaboration identity, provenance data, a site location for provenance data, data concerning necessary harmonisation, cryptographic or password data, data enabling the recipient to join a web service supporting the Collaboration, and other such data enabling web-supported interaction with the content. Upon opening the Version the user sees and can modify or re-transmit the content in a display that makes use of the Wrapper information to enable and organize access to the content, to the provenance information and related files, or other web-enabled interaction with the content and the Collaboration.

### BRIEF DESCRIPTION OF THE DRAWINGS

FIG. 1: Editing of a multi-author files in a typical natural workflow.

FIG. 2: Selection menu for choosing a CollaborationID.

FIG. 3: Flow of use of a Version file holding content data directly.

FIG. 4: Flow of use of a Version file with access directions to content data.

FIG. 5: Flow of use of a Version file with access directions to encrypted data.

FIG. 6: Implementation components and transactions between them.

FIG. 7: The device by which a Version is created and sent.

FIG. 8: The device by which a Version is received and opened.

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. By default, “net” or “network” in this document refers to the World Wide Web, but a more limited system such as an intranet may be substituted wherever this meaning is not repugnant in the context of this specification and the relevant art.

Unless otherwise defined, all terms (including technical and scientific terms) used herein have the meaning commonly understood by one of ordinary skill in the art to which this invention belongs. It will be further understood that terms used herein should be interpreted as having a meaning consistent with their meaning in the context of this specification and the relevant art and will not be interpreted in an idealized or overly formal sense unless expressly so defined herein.

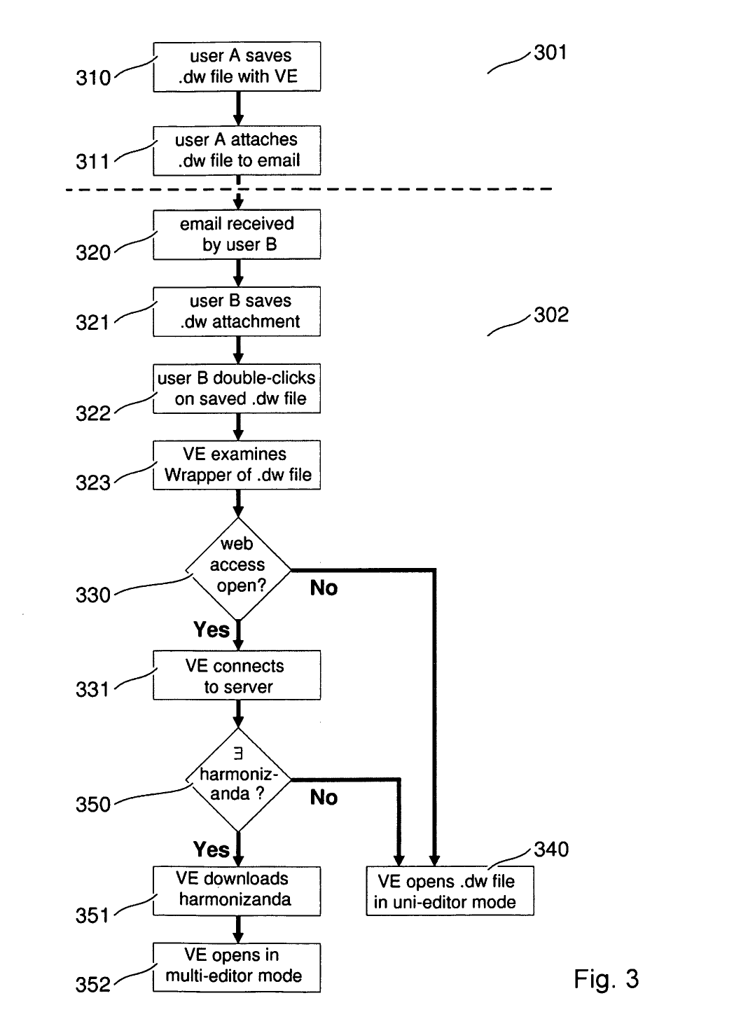

The present invention is described below with reference to block diagrams and/or flowchart illustrations of methods, apparatus (systems) and/or computer program products according to embodiments of the invention. It is understood that several blocks of the block diagrams in FIGS. 3, 4 and 5, and combinations of such blocks, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium or combination of media that can contain, store, communicate, propagate, or transport the program for use by or in connection with the instruction execution system, apparatus, or device. Such a computer-usable or computer-readable medium may be but is not limited to an electronic, magnetic, electromagnetic, optical, infrared, or semiconductor system, apparatus, device, or propagation medium. A non-exhaustive list of more specific examples of computer-readable media would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

We define a Version of a file as a file saved in a format that includes (beside giving access to the textual, geometric, video or other such content data appropriate to its type) Wrapper information readable by appropriate software. In our preferred embodiment the content data of the file are embedded in the version, but this may be replaced by details specifying a means of access to this content. Of the essence of the Version is that it is a file, appearing as such to the user by the means characteristic of the OS in use, and open to copying and transfer by means applicable to general files. The typical transfer is from the system of one user (referred to as A) to that of a user B, by e-mail or other transmission, but the special case of transfer within the user's control (to a different folder, or another computer on which the user works, etc.) is included in the discussion below by the understanding that the recipient user B may be the same as the originating user A. Much of the maintenance of relationships between files that is supported by the method described below is equally relevant to this situation, even if the user is the sole participant in the Collaboration.

The Wrapper information must include a unique CollaborationID identifier for the Collaboration of which the file forms a part, and may include other types of information, in various embodiments as described further below. If the file was created by editing a previously existing file, it will normally inherit the CollaborationID of that file: if the file was created by editing a new blank document, a new CollaborationID must be assigned in the process of opening the new blank document, in the process of saving the edited version with its content, or at any convenient stage between these two processes. Further, it contains data such as a uniform resource locator (URL), giving network access via a net to systematic information concerning files in the same Collaboration. In a preferred embodiment, this information is on a server which also stores copies of the files, and may perform various comparisons and provenance analyses of them. In this preferred embodiment, the Version is uploaded to the server at the earliest opportunity: immediately upon creation if the web is active, at the next detected moment of net access otherwise.

The tasks of creating the Version and optionally of uploading it are performed by software running locally, which we will here refer to as the Versionizer. This may take the form of a locally installed application, or a rich internet application (RIA) enabled by a cross-operating system runtime such as Adobe Integrated Runtime (AIR), OpenLaszlo, or Google Gears, which is pre-installed (like a browser, with which it typically interacts) and enables the RIA both to test whether a network connection is available, and if so make use of it (as a Java applet can do) and to save files in local system resources (as an applet cannot). In general, such a runtime can function either within the context of a browser, or independently. The runtime is typically installed once for all on the local system, with installation giving it the necessary privileges, whereas the RIA acts as a script within it, and requires downloading but not installation. Once cached after first use, the speed of availability of a RIA is similar to that of an installed program. Our preferred embodiment has been implemented in this way using AIR, but many alternatives will be evident to those skilled in the art, within the spirit of the present invention.

The Versionizer function is in our preferred embodiment incorporated within software that enables editing, collation of different versions, and other such functions (as described in the above-cited applications to the USPTO), including the modification and collation of documents, images, videos, music files, programs, game states (specifying the current status of modifiable elements such as players, weapons, movable pieces, etc.), mechanical designs, and so forth. In this case the Versionizer function may be part of a frequent ‘Autosave’ or of the ‘Save’ or ‘Save As’ command offered to the user, though in general we deprecate the usual ‘Save’ as a destructive command without the possibility of Undo after closing. Our preferred editing environment maintains a fully recoverable history, including Undo restricted by the user's choice to a section of a document, as disclosed in the above-cited USPTO applications: such software would normally create a Version file upon exit, and optionally at chosen times such as daily, or upon certain triggers such as a user's work moving to a new section of the current document. However, the Versionizer function may also be embedded (by code revision or as a plug-in) in a more traditional editing program. In an alternate embodiment, it may also act as a separate program, acting to create a Version (in the sense of the current invention) from an existing file. In this case it cannot extract the appropriate CollaborationID from a previous Version, as an editing tool can, and will require such means as the user selection menu 200 in FIG. 2 to choose one. (The window 210 shows a current set of CollaborationIDs, of which the option 210 is highlighted: pressing Enter on the keyboard would select it. Alternatively the user may click on one of the others, making it the selection, or click in the box 220 and type a new CollaborationID. Pressing Delete when a CollaborationID such as 210 is selected deletes it from the Versionizer's continuing memory of current CollaborationIDs. Many variants of this interaction will be evident to one skilled in the art, within the spirit of the present invention.) Such a menu may also be provided in association with a Versionizer function embedded in an editing program, to permit the user to set a CollaborationID where the ‘file edited from’ CollaborationID is inappropriate or non-existent.

In our preferred embodiment the Versionizer also automatically creates a remote copy of the Version, preferably including all available provenance data. If the users have agreed on encryption in a form where the remote server never contains an unencrypted form, the decryption key is contained in only the locally saved Version.

User A may in the standard way attach to an out-going e-mail the Version created by any of the above methods, or by such similar methods as will be evident to one skilled in the art. (In our preferred embodiment the Version is presented to the user, for e-mail, opening or other purposes, by the general name of the collaborative work, leaving version management as a more fully automatic function.) In particular, a Versionizer function may be included in the user's email client, provided that this client has suitable privileges or (if it is a webmail service, with no local installation) that it can call upon those of the browser through which it is used. As usual with an e-mail system, this mail may be sent to an individual, to a plurality of separately selected individuals, or to all members of a list. Where the Versionizer is integrated with the e-mail software, either by incorporation within the e-mail software or by invoking it, the list may be maintained within the Versionizer as a list of e-mail addresses of collaborators associated with the relevant CollaborationID. This list is invoked by default when a Version is mailed, but preferably can be modified or over-ridden by the user who initiates the mailing. Many alternative means of communicating the Version file will be evident to one skilled in the art, within the spirit of the present invention. In particular, in the case where the recipient is the same as the creator, the transfer is typically by moving or copying the file from one folder to another, by carrying it on a portable drive to another computer on which the same user works, and other such means, though e-mailing a file to oneself is a common and often convenient practise.

Upon receipt of the e-mail with the Version as attachment, a user B (commonly but not necessarily distinct from user A) saves the attachment in the standard way for that user's mail software and operating system (OS), in a directory, in a folder, or in such other manner as the OS may provide to make it findable again later. This user has no compulsion to follow the sorting system preferred by others. The storage where it is saved may be local, remote and accessible via a net, or both.

Upon opening the received attachment, either from within the e-mail software, from a browser's Download function, or from the file navigation system native to the receiving user's OS, various events take place, according to the embodiment. We describe first the simplest case, shown in FIG. 3. The flow in this diagram moves by a standard email transaction (not discussed in further detail) from the area 301, involving user A and user A's computer, to the area 302, involving user B and user B's computer.

In this embodiment the assumption is that each user in the collaboration has installed the Versionizer as a part of a multi-version editor such as that disclosed in “A Method and System for Harmonization of Variants of a Document”, cited above: we call this an editor which includes Versionizer functionality a ‘versionizing editor’, or VE. Every Version file is identified as being a version by the mechanism of file extension of its name, a concluding string of letters after a dot. We refer to this extension as an ‘indicator’ to users and to the OS that the digital object is to be recognized as a Version file: any other method of making the information available (such as including it with the ‘date created’ metadata currently attached by many operating systems to a file, and stored and transferred with it though being neither content nor part of the filename) may be used within the spirit of the present invention. In our current embodiment this extension is “.dw”, which we shall therefore use for exemplary purposes. Part of the installation process registers the software with the OS, so that just as a “.ppt” file is automatically opened by Microsoft PowerPoint (unless the user has taken special action to the contrary), a Version such as fubar.dw is automatically opened by the VE.

User A saves 310 a Version from the VE, attaches it 311 to an e-mail message, and sends it. Optionally, with suitable integration between the VE and user A's mail environment, these two steps may be jointly invoked by a single user command, which may also the step of providing the email environment with a default list of addresses associated with the Collaboration with which the version is associated. Many such optimizations of the user interaction scheme will be evident to one skilled in the art, within the spirit of the present invention. Our preferred embodiment integrates into the Save step 310 an action of uploading a copy of the Version to a central server, if web access is available, or of tagging it for upload at the next occasion when web access is detected, but such central saving may also be performed separately. In the embodiment of FIG. 3 it is assumed that such upload has been performed for previous Versions (if any) that belong to the same Collaboration.

User B, one of the addressees of the message, receives it 320 and saves 321 the Version file attached. Alternatively, user A may save the Version in a physical medium such as but not limited to a flash drive or a writable CD, which is then physically transferred to user B, connect to a shared folder on user B's computer or to which user B has access and copy the Version there, or transfer a copy of the Version to B's control by any other means known to those skilled in the art. A copy then exists in B's domain of control.

User B then or later makes a standard request to open it, such as double-clicking 320 on the file's icon in a folder, clicking Open in a browser-created list of recent downloads, selecting the file in an Open process operated by the VE, typing suitable text into a command line, or another such means known to those skilled in the art. The VE examines 323 the file, and tests 330 whether web access is currently available. If it is not, the VE opens 340 the file for editing, displaying and making modifiable the content of this single file by means familiar to those skilled in the art of word processor software, computer-aided design, image manipulation software, or such other file modification software as may be appropriate to the content of the particular Version file. An embodiment may support this step for files of a single content format, such as .doc, .pdf or .jpeg, of a single class such as ‘document’ or ‘image’ which may include multiple content formats, or multiple classes.

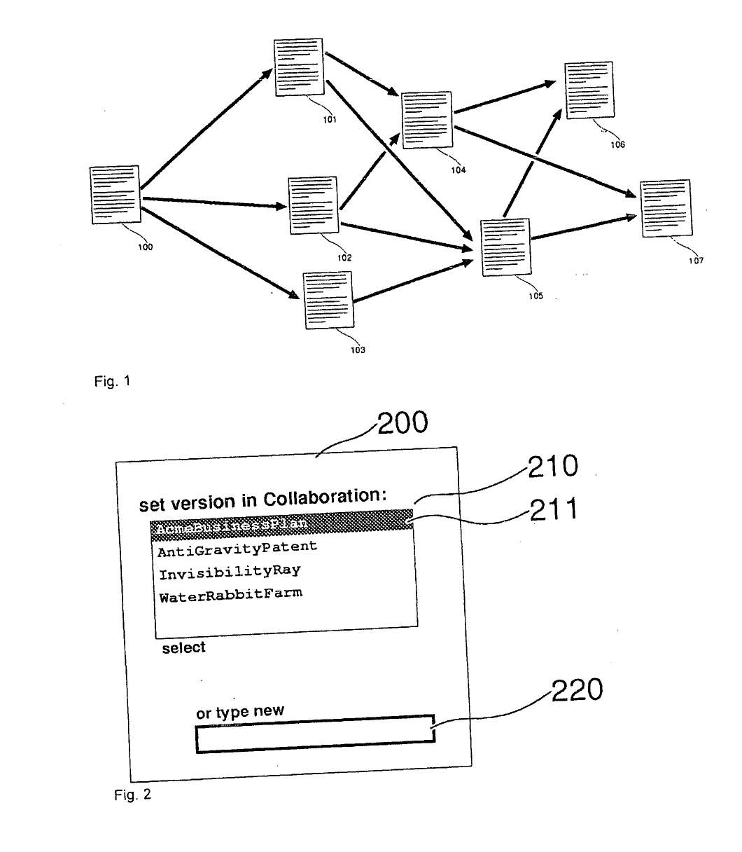

If step 330 does discover web access, the VE connects 331 to a server whose web location is specified in the Wrapper, transmits the CollaborationID and Version information such as creation date and which Version's content was modified to create it. With this information and its record of previous transactions with users belonging to the Collaboration, the server determines 350 whether there exist known harmonizana: items requiring the current Version to be harmonized with them, or otherwise appropriate for consideration in further modifying it. This includes, but is not limited to, conflicting Versions: other such items may be a request for rewriting along certain lines, a document (perhaps from an external source) which should be taken into consideration, an update of a spreadsheet from which the Version uses data, an earlier item that the receiving user opts to recall while considering the newly received Version, etc. Note that the Version from which the current Version was derived is distinct from the current Version, but not defined as in conflict with the current Version, since the differences are defined to have been resolved in the current Version's favor. The determination 350 may be by various means, such as establishing the descent tree illustrated in FIG. 1 by means disclosed in the patent applications “A Method and System for Harmonization of Variants of a Document” and “A Method and System for Digital File Flow Management” cited above, by the methods therein disclosed or otherwise, and identifying unresolved leaves of the descent tree, corresponding to Versions with changes that have not yet been assimilated; or by establishing whether other Versions have been created with the Collaboration since the creation of the Version from which the currently considered Version was derived; or by establishing whether other relevant material has been added to the Collaboration data since the creation of the Version from which the currently considered Version was derived; or by such other means as may be found by one skilled in the art. (The means of identification of harmonizana is not of the essence of this embodiment of the present invention, which merely requires that such a step be performed by some means, as must the transfer of the .dw file from user A to user B.) If step 350 determines that there are none, the VE opens 340 the file for editing, displaying and making modifiable the content of this single file, as already discussed, If step 350 determines that a non-empty set of harmonizana exists, the VE downloads them 351 for harmonization, optionally together with a reference Version selected as in the applications cited above. The VE then displays this plurality of harmonizana in an integrated manner facilitating their harmonization, as disclosed in the above-cited applications, or otherwise.

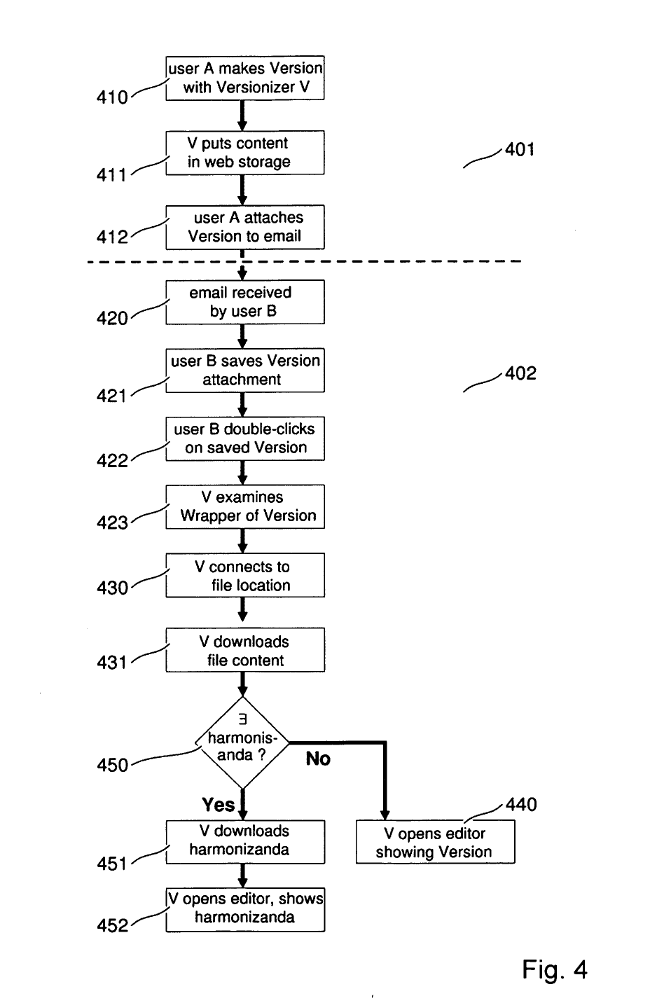

In an alternative embodiment (FIG. 4), particularly applicable where trustworthy web access is available, and where files may be large enough to infringe e-mail limits on attachment size, the Version does not directly hold the content data, When the user 410 calls upon the Versionizer (via a VE, via a function of e-mail software, or by such other means as will be evident to one skilled in the art) to save a Version, the Version stored locally does not contain the content data directly. Instead, the Versionizer stores the content data in a web-accessible location, which may be a dedicated server, a folder shared over the net or an intranet, or any other such location that receivers like user B will be able to access, without a special step for B such as mounting a remote folder. The Version then includes the data needed for such access, including the address of the location, an identifier to the location's operating software of the specific content to be accessed, and optionally a password or other key or keys required for access to be available and to equip the receiver to act in turn as a content modifier, Version originator, and Version disseminator. In our preferred form of this embodiment, such access data are transparent to both sender and recipient, who experience the already-familiar action of saving and sending a mail.

At the next step, user A communicates the Version to user B, who receives it: paradigmatically this communication is by the standard mechanisms of attaching 412 a file to an email that user A sends, receiving 420 the email and saving 421 the attachment, but any means of file transfer will suffice. Activity moves from control 401 by user A to control 402 by user B. When user B double-clicks 422 or otherwise activates the saved file, the Versionizer V installed in user B's environment examines the Wrapper of the Version. The Versionizer V connects 430 to the location where the content was stored in step 411, and downloads the content, or shows an appropriate error message in case of failure. In our preferred form of this embodiment the Versionizer then 450 queries the web storage software used in step 411 for the existence of any harmonizana, as described above. If no such are found, the Versionizer opens an editing window allowing user B to modify the received content, and in due course create a new Version. By our preference the editing software is integrated with the Versionizer, but as an alternative the Versionizer may open independent software such as Microsoft Word and pass it the content data. If harmonizana are found, the Versionizer 451 downloads them and 452 opens their content for collation and editing, as a set of windows in a classical editing program or as an integrated display in an editor designed for document harmonization.

As an alternative in any of the above-described embodiments, instead of opening the files in a locally installed application or RIA, the Versionizer may open them in a web-based editor. If this web service is part of, or is integrated, with the server from which downloads are made in FIGS. 3 and 4, then the download steps may be omitted, since the content data are already in situ. The corresponding changes in the flow will be evident to those skilled in the art.

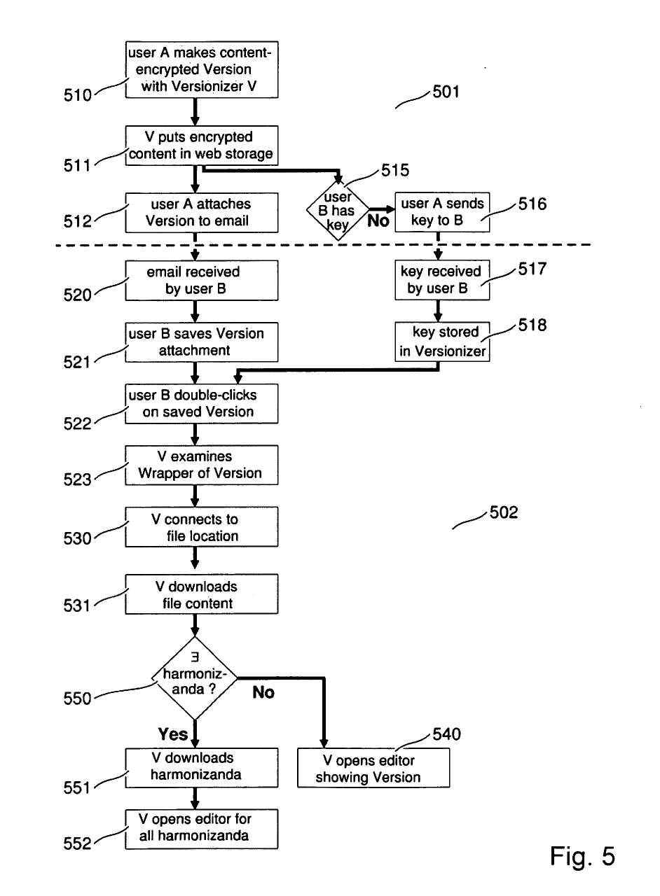

In a further alternative embodiment (FIG. 5), as part of the creation process 510 the Versionizer encrypts the content data, includes a decryption key in the Wrapper, and 511 places the encrypted data in the remotely accessible storage used. If user A sends the Version to user B, it will normally be necessary for B to decrypt the content. If 515 user B already has the necessary key, as may be tested by many means evident to one skilled in the art (querying a record, querying user B's Versionizer via the network, querying B personally, etc.), no further action on this point is needed. If user B does not have the necessary key, in one embodiment, the decryption key may be included (not shown as a separate step) in the Wrapper. This is at no point readable or accessible to the software operating the remotely accessible storage, since the Wrapper is transmitted directly between individual user's environments, and created and read by locally operating Versionizer embodiments. The data cannot be read and compromised at the server, without a means to break the cipher. In an alternate embodiment, if the key is not 515 already available to user B, user A transmits it separately 516 by such means as will be evident to one skilled in the art, including but not limited to a separate email (optionally using a different account or service), steganography, text message, telephone call, or other such electronic means, or conveying a message physically stored as writing, digital record, etc., in an appropriate medium by messenger, carrier pigeon, postal service or other such means. If sufficiently accurate telepathic communication is available to users A and B, then its use for this purpose is within the spirit of the present invention. User B receives 517 the key, and enters it 518 in the data storage accessible to user B's local embodiment of the Versionizer. It is thus available to steps 522 onwards, in which that embodiment of the Versionizer interacts with the Version.

Transfer 512 and 520 from the control 501 of user A to the control 502 of a recipient user B occurs as before, typically but not necessarily by e-mail. When user B has 521 saved the Version, opening steps 522, 523, 530 and 531 occur as before, with optionally a test 550 of whether there exists other material requiring harmonization. If not, or if this test is omitted from the embodiment, the Versionizer opens 540 an editing or read-only display 540 of the content data, as decrypted using the key received in the Wrapper. If conflicting versions are found to be available, the Versionizer 551 downloads them and by default opens them all 552, in an integrative editor if available, in separate windows if not.

When the key is included in the Wrapper, the encryption security in FIG. 5 is as transparent to the user as the remote storage and access management in FIG. 4, and has a value independent of the version management, optional in this version. When this option is included, our preferred embodiment uses the same decryption key throughout a collaboration, so that harmonizana downloaded 551 may be decrypted without a separate protocol for obtaining their keys. We observe that the encryption limits the assessment of conflict open to the remote storage software in step 550, since it cannot apply the internal comparison methods of “A Method and System for Digital File Flow Management” cited above. However, if the editing system on each user's system transmits to it records of which Versions were opened in the creation of a particular Version, it can maintain a full descent tree. Even without support for a descent tree, it can apply the above-mentioned criterion of establishing whether other Versions have been created with the Collaboration since the creation of the Version from which the currently considered Version was derived, or such other means as may be found by one skilled in the art. Internal comparison methods can however, be delegated in a distributed fashion to the installed copies of V, which need only report to an analysis program a list of discovered matches and differences identified by arbitrary names, without giving their content. A central server, or one of the installed copies of V, can reconstruct the descent tree, thus making it available for a richer test 550 than the server alone could apply to files that it cannot decrypt.

The above embodiments may be described as ‘climax forest’ embodiments, where the propagation of Versionizer installations (like the propagation of trees) has reached all potential locations. In this situation, we prefer the use of a specialized extension such as .dw, and the standard opening protocols made use of as above. However, in the propagation phase it is important to minimize the issues of installation. We assume that the transmitting user A has installed the appropriate Versionizer (otherwise the method cannot begin) and address what happens when an email with a Version attachment is sent to a user B who does not have the corresponding Versionizer installed.

In a ‘propagating’ embodiment the saved Version is given the final extension .html, or such other extension as may be recognized by the operating system used by a Version recipient as identifying a file to be opened by a browser. Optionally this may be preceded by an extension specific to the embodiment, such as .dw, but this is more useful for user recognition of the file type than for cross-platform automatic behavior. When the browser opens the file, before meeting any content calling for the display of a page it encounters in the Wrapper a script directing it to see if a specified cross-operating-system runtime is installed. Various events may then take place:
a) If this cross-operating-system runtime is found, a script is passed to it which enables it to run the Versionizer (including downloading additional script as necessary, from an appropriate source). The embodiment then proceeds as already described.
b) If the required cross-operating-system runtime is not found, the browser is directed to a site which invites and enable the user to install it and place a local version of the software on the desktop, preferably with a minimum of user interaction beyond signifying agreement where required by security considerations, and optionally acknowledgement of receipt of an e-mail confirmation message. Optionally, the site may show a preview of the file, in the form of a first page, a compressed view, or otherwise. The embodiment then proceeds as in (a).
c) If the user does not agree to installation of the cross-operating-system runtime, or the site is not found, the browser suggests that the user open the file by standard means with an independent program, such as by dragging it to the icon for a regularly used editor, changing the extension if necessary most software can handle a file that is internally in the format it is designed to read, even if the file has a misleading extension. This method requires arranging that the material acted upon as ‘Wrapper’ by the Versionizer or browser is seen as a harmless intrusion like comment, not as destructively bad data, by the program to which it is passed. Alternatively, with some browsers, a Wrapper-free form of the file may be saved, with an extension associated with the independent program.
d) If the content data of the file is not a direct part of the Version, the file must be downloaded from a server. The script invokes the browser's standard download mechanism, supplies an extension associated with the independent program, and signals to the server that a Wrapper-free version is required.

As will be evident to one skilled in the art, many similar means may be provided to avoid that a recipient user who is not already equipped with a Versionizer should receive something she finds less useful than a standard attachment (rather than more, as is the intent of the present invention). Except where the material is encrypted, and the Wrapper must be read by the Versionizer to find and use the decryption key, receipt of a readable file by such a user may be guaranteed. Either opening it without a Versionizer, or gaining the added functionality of Versionizer use, needs only a few acceptance clicks rather than a challenging technical process. Alternatively, instead of a cross-operating-system runtime script, a standard download and installation of an operating-system-specific Versionizer or Versionizing Editor application can be arranged in the same manner.

Optionally, the saved Version may include a ‘one-time key’ embedded in the Wrapper. If the site has encountered this key before, it does not give access to the data specific to the collaboration, though it may create a membership for the user who has activated the file and/or invite this user to make use of the general facilities of the site. Optionally, the file may be encrypted (besides any other encryption) in a manner that can only be decrypted if this is the first time that the one-time key is presented to the site. If decryption is performed by the server, the server requires this key as a pass-word: if decryption is performed by the local Versionizer, the server approving the one-time key passes to it a necessary decryption key or other enabling message. The USPTO application by Poston, Shalit and Dixon, “A Method and System for Invitational Recruitment to a Web Site” (20080208867 A1), herein incorporated by reference, discloses the transmission of a one-time membership-invitational key, embedded in a URL link. Such a key may also be transmitted outside the Wrapper but within the same e-mail, combined with a message that if the recipient will be permanently able to access the file or the related material if she or she uses the membership link (either by membership, or by repeated e-mail invitation at the end of each session), but that merely opening the file with a browser will suffice for remote access. This mechanism, without the aspect of inviting membership in an on-going collaboration, may also be used to request a one-time contribution: for instance, to add an opinion on a candidate or a proposed line of action, which the writer will not be given a later chance to revoke.

In general, in our ideal embodiment a Version may always be opened in any browser (subject to permissions and encryption) simply by dragging it to a window or icon of the browser, opening it with the browser's File Open menu command, or use of a command line or Run box, though double-clicking on it should open a Versionizing Editor if such is installed. Where an operating system is capable of parsing a filename ending with a double extension, such as fubar.dw.html, a double click should result in the behaviour “If a Versionizer is present, open with that: else, open with the browser currently registered to open HTML files”. However, such parsing and such conditional behaviour are not universally supported, the means for setting up such behaviour is not universal, and setting it up may require specific actions by the user (rather than an automatic registration process), contrary to our preference for un-intrusive service. These matters being outside the control of most creators of software, the use of double extensions is not currently our preferred embodiment of the present invention. The propagating embodiment above uses the .html or .xmi extension, which in current browsers requires that at least the first-encountered parts of the Version file take the form of acceptable mark-up language. In the most negative browser environment, only the steps that request that the browser connect to a site and pass it a string (for example, embedded in the URL) may be practical: it is then up to the site to handle the user interaction, including opening in a browser window a file copy saved on the server by the originating user, if the user's browser does not enable automated upload of a file contained in the Version.

In all those embodiments where the file transmission mechanism (email attachment or other) is integrated with the Versionizer, a record of transmission events may be constructed and retained on a central server or in a distributed manner across the installed Versionizers, becoming available for analysis of descent, providing a ‘paper trail’ for the evolution of the document, or other such uses. Where it is not so integrated, records of saving events and opening events can support a similar functionality.

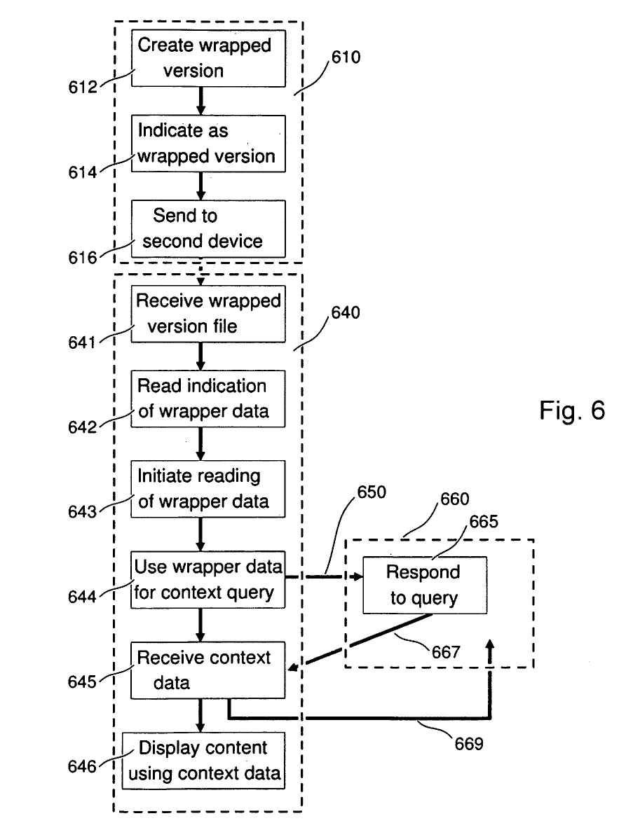

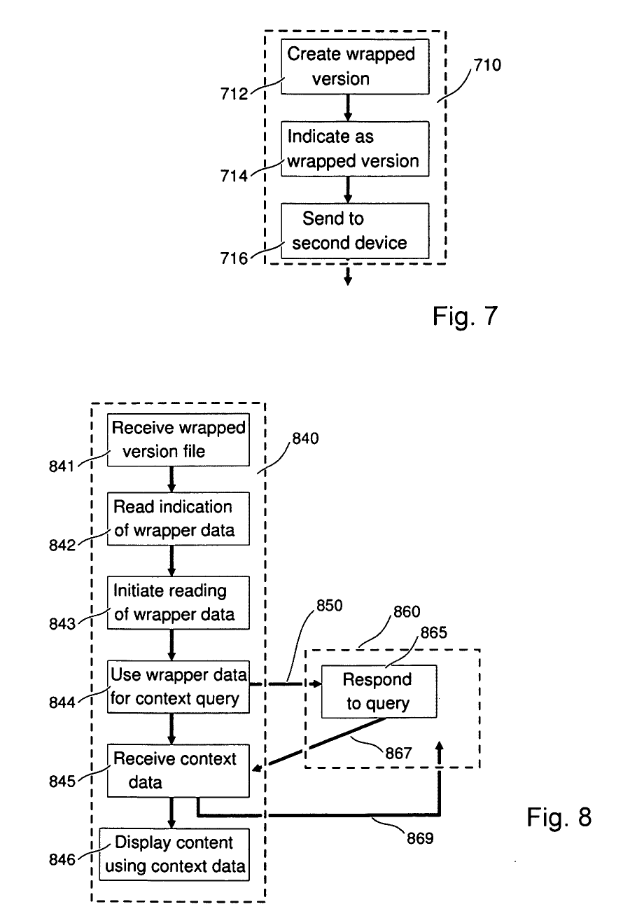

An exemplary implementation of the steps prescribed by the present invention is shown in FIG. 6, with reference to the devices involved. User A interacts directly with that user's communication device 610, such as a computer or the like, which is part of a typical work environment that permits editing and other activities on available data. (This remains true when user A is employing a web-based editor, since the user's processor continues to handle the interface seen by user A, using its own memory, even where some processes are outsourced to other devices via the web. Such outsourcing is well understood by those skilled in the art, and is not of the essence of the present invention, so these other devices are not shown.) The communication device 610, under the direction of user A, creates 612 a Version with a Wrapper and in step 614 applies an indicator that marks the resulting file as a wrapped version. User A then typically invokes activity again in the processor 610 to send 616 the Version to a communication device 640, such as a computer or the like, under the control of user B. (This may require recovery of the wrapped Version from storage, either locally or from another storage site reachable by the communication device 610.) The transmission 616 will typically be an electronic mail system or a file-sharing system to which both user A and user B have access, though physical transport of memory such as a CD, flash drive or disk by post office or courier is also a transmission system usable in the present invention, as is any other component that effects the transfer of the Version.

The communication device 640 of user B receives the Version in step 641 (corresponding to steps 320, 420 or 520 in other figures), typically saving it in long-term memory storage, which may again be either local or remote. The device 640 reads the indication created in step 614, recognizes the file as a wrapped version, and initiates the reading of the wrapper data by an installed or rich internet application. It uses the reported wrapper data to send 650 a query to another device, application or program module 660, which may be a server dedicated to such data, the communication device 610 of the user A who sent the file, or another user with whom both are collaborating, or an application running within user B's communication device 640 that records local events involving files with the same CollaborationID. The device or application 660 determines 665 an answer to the query sent 650, and transmits 667 that answer to user B's communication device 640, where it is received and read 645. In a preferred embodiment, it will report 669 an update of the status associated with the CollaborationID to the record-keeping entity 660. The communication device 640 then displays the content of the original file in manner modified by the context data received in step 645.

One component of the present invention, then, is a first communication device equipped to create 712 a Version with a Wrapper and in step 714 applies an indicator that marks the resulting file as a wrapped version, and to send 716 the Version to a communication device 640 under the control of user B, by a multiplicity of means that will be evident to those skilled in the art.

In an embodiment of the present invention, we instantiate the first communication device 710 by a processor arranged to perform the steps 712 and 714, and a transmission arrangement configured to perform step 716.

A second component of the present invention is a second communication device 840 equipped to receive 841 and save the Version. The device 840 reads 842 the indication that the file is a wrapped Version, and initiates the reading of the wrapper data by an installed or rich internet application. It uses the reported wrapper data to send 850 a query to another device, application or program module 860, which may be a server dedicated to such data, the communication device 810 of the user A who sent the file, or another user with whom both are collaborating, or an application running within the device 840 that records local events involving files with the same CollaborationID. The device or application 860 determines 865 an answer to the query sent 850, and transmits 867 that answer to the device 840, where it is received and read 845. In a preferred embodiment, it will report 869 an update of the status associated with the CollaborationID to the record-keeping entity 860. The communication device 840 then displays the content of the original file in manner modified by the context data received in step 845.

In an embodiment of the present invention, we instantiate the first communication device 840 by a receiving arrangement configured to perform step 841, a processor arranged to perform the steps 842, 843, 844, 845 and 850, and optionally (if they do not occur on an external system) steps 865 and 867, and a display arrangement configured to perform step 846.

The invention relates to a method for distributed coordination of access to digital files, comprising the steps: of constructing a Version of a digital file modified by a first user that gives access to the content therein and includes Wrapper data enabling the execution of the following further steps: saving the Version in a location visible and accessible to said first user; transmitting the Version to one or a plurality of recipient users; saving the Version in a location visible and accessible to a recipient user; enabling the recipient user to activate the saved Version; using the Wrapper data to seek a directed contact with a digital system external to the control domain of the recipient user; obtaining data from the external system; and, using the externally obtained data to provide to the recipient user an augmented display of the content data of the version.

In an embodiment of the method, the augmented display includes interactive means to modify the content data, said modifications being available for the creation and dissemination of a new Version according to the steps already described.

In an embodiment of the method, the augmented display is controlled by software running on the recipient user's computer, or by software running on a remote computer.

In an embodiment of the method, the content data are included within the Version.

In an embodiment of the method, the content data are stored elsewhere, and the Wrapper data include the information required to obtain a copy therefrom, and the data obtained from the external system include the stored content data.

In an embodiment of the method, (i) the content data are stored elsewhere in an encrypted form, (ii) the Wrapper data include the information required to obtain a copy therefrom, (iii) the data obtained from the external system include the stored content data, (iv) the Wrapper data or a separate communication includes a key enabling decryption and optionally a key for later creation and dissemination of a new Version according to the steps already described, and (v) the augmented display shows the resulting decrypted form of the content data.

In an embodiment of the method, the data obtained from the external system include information concerning items with which the user may harmonize the Version.

In an embodiment of the method, copies of the items with which the user may harmonize the Version are downloaded to the recipient user's locally visible and accessible environment, and made available for the augmented display.

In an embodiment of the method, copies of such of the items with which the user may harmonize the Version as are already extant in the recipient user's locally visible and accessible environment are identified and made available for the augmented display.

In an embodiment of the method, an application in the external system opens both the content data of the Version, uploaded if necessary to the external system, and the contents of the items with which the user may harmonize the Version.

In an embodiment of the method, the content of the items with which the user may harmonize the Version is displayed in a set of independent windows.

In an embodiment of the method, the content of the items with which the user may harmonize the Version is displayed in a single integrated window.

In an embodiment of the method, an item stored by a collaborator is considered as requiring harmonisation if it post-dates the Version from which the transmitted Version was derived.

In an embodiment of the method, an item is considered as requiring harmonisation if a descent tree maintained on the external system or on a system accessible to it does not show the transmitted Version to be in part derived from it.

In an embodiment of the method, the steps of using the Wrapper data to seek a directed contact with a digital system external to the control domain of the recipient user, obtaining data from the external system, and using the externally obtained data to provide to the recipient user an augmented display of the content data of the version, are performed by a program installed on the recipient user's computer, directly invoked by the step of enabling the recipient user to activate the saved Version.

In an embodiment of the method, the steps of using the Wrapper data to seek a directed contact with a digital system external to the control domain of the recipient user, obtaining data from the external system, and using the externally obtained data to provide to the recipient user an augmented display of the content data of the version, are performed by a cross-operating-system runtime script installed on the recipient user's computer.

In an embodiment of the method, the activation invokes a web browser, which responds to data in the Wrapper by seeking a cross-operating-system runtime and if such a runtime is present, presenting the runtime with a script enabling it to perform the steps of using the Wrapper data to seek a directed contact with a digital system external to the control domain of the recipient user, obtaining data from the external system, and using the externally obtained data to provide to the recipient user an augmented display of the content data of the version, optionally including the download of additional script.

In an embodiment of the method, the activation invokes a web browser, which responds to data in the Wrapper by seeking a cross-operating-system runtime and if such a runtime is absent, opening a web page capable of operating as a web service the step of using the externally obtained data to provide to the recipient user an augmented display of the content data of the version, or of installing the runtime and enabling local performance of a script, or of passing the content to an independent program designed for editing or other modification of files.

In an embodiment of the method, the content data of the digital file constitute a document, a geometric or mechanical design, a spreadsheet, a music file, a video file, a mixed-media file, a musical score, source code for a computer program, executable mathematical symbolism, or a game state.

In an embodiment of the method, a record is kept of events belonging to one or more of the classes: Version creation, with timestamps and data as to previous Versions drawn upon, Version transmissions; Version receptions; Version openings.

An embodiment of the method includes the automatic local or remote saving of a Version with Wrapper data as appropriate.

In an embodiment of the method, the automatic local or remote saving is on a continuous or highly frequent basis whenever the user is editing and connected to the server.

In an embodiment of the method, the most recent Version is presented to the user in mailing or other sharing interactions under the general name of the collaboration, sparing the user any nomenclature of version control.

In an embodiment of the method, the Wrapper includes a key that the external system will not accept more than once, and without which the external system withholds remote opening or decryption of the file or a key required for local opening or decryption of the file, as appropriate.

In an embodiment of the method, it achieves distributed coordination of access to digital files by the steps of: making a version of a file applying wrapper data to the version; indicating with an indicator the version as being a version with wrapper data; sending the version file to a receiver; receiving the version file at the receiver; reading the indicator of the version file; initiating application to read the wrapper data, using the wrapper data to access the version, related versions and/or collation data of different versions of the file, and displaying the version, related versions and/or collation data of different versions of the file.

In an embodiment of the invention, a computer program product includes a computer usable medium having a computer program logic stored therein to enable a computer system to perform the method as described above.

In an embodiment of the invention, a system comprising a first computer of a first user is arranged to create a version of a file containing access information and version data, called wrapper data, said wrapper data enabling a receiving user that receives the version from the first user to retrieve collation data of different versions of said version from a storage of different versions.

In an embodiment of the invention, the system further comprises a receiving user.

In an embodiment of the invention, a computer program product includes a computer usable medium having computer program logic stored therein to enable a computer system to perform the steps of making a version of a file applying wrapper data to the file, and indicating the version as being a version with wrapper data with an indicator.

In an embodiment of the invention, a computer program product includes a computer useable medium having a computer program logic stored therein to enable a computer system to perform the steps of initiating an application to read the wrapper data, using said wrapper data to access the version, related versions and/or collation data of different versions of the file, and displaying the version, related versions and/or collation data of different versions of the file.

What is claimed is:

1. A method in a network device for distributed coordination of access to digital files, comprising the steps of
in a first communication device, making a version of a file by applying wrapper data (including but not limited to a CollaborationID) to the file, whose original content data remain available;
in the first communication device, indicating with an indicator the version as being a version with wrapper data;
sending the version file to a second communication device;
receiving the version file at the second communication device;
reading the indicator of the version file in the second communication device,
initiating an application to read the wrapper data in the second communication device;
using the wrapper data in the second communication device to access the version, related versions and/or collation data of different versions of the file, in a local or other store that contains records relating to other files with the CollaborationID found in the wrapper; and
displaying the version, related versions and/or collation data of different versions of the file in a display of the second communication device.

2. A method as in claim 1, where the display in the second communication device includes interactive means to modify the content data, said modifications being available for the creation and dissemination of a new version.

3. A method as in claim 1, where the second communication device is a computer and is controlled by software running on a recipient user's computer, or by software running on a remote computer.

4. A method as in claim 1, where either the content data are available by inclusion within the version, or they are stored elsewhere, and the wrapper data include the information required to obtain a copy therefrom, and the data obtained from the external system include the stored content data.

5. A method as in claim 1, where (i) the content data are stored elsewhere in an encrypted form, (ii) the wrapper data include the information required to obtain a copy therefrom, (iii) the data obtained from the external system include the stored content data, (iv) the wrapper data or a separate communication includes a key enabling decryption and optionally a key for later creation and dissemination of a new version according to the steps in claim 1, and (v) the display of the version, related versions and/or collation data of different versions of the file shows the resulting decrypted form of the content data.

6. As in claim 1, where the data obtained from the external system include information concerning items with which the user may harmonize the version.

7. As in claim 6, where copies of the items with which the user may harmonize the version are downloaded to the recipient user's locally visible and accessible environment, and made available for display of the version, related versions and/or collation data of different versions of the file.

8. As in claim 6, where copies of such of the items with which the user may harmonize the version as are already extant in the recipient user's locally visible and accessible environment are identified and made available for display of the version, related versions and/or collation data of different versions of the file.

9. As in claim 6, where an application in the external system opens both the content data of the version, uploaded if necessary to the external system, and the contents of the items with which the user may harmonize the version.

10. As in claim 6, where the content of the items with which the user may harmonize the version is displayed either in a set of independent windows, or in a single integrated window.

11. As in claim 6, where an item stored by a collaborator is considered as requiring harmonisation if it post-dates the version from which the transmitted version was derived, or if a descent tree maintained on the external system or on a system accessible to it does not show the transmitted version to be in part derived from it.

12. A method as in claim 1, where access and display are performed by a program installed on the recipient user's computer, directly invoked by reading the wrapper data, or by a cross-operating-system runtime script installed on the recipient user's computer.

13. A method as in claim 1, where initiating an application to read the wrapper data invokes a web browser, which responds to data in the wrapper by seeking a cross-operating-system runtime and if such a runtime is present, presenting the runtime with a script enabling it to perform the steps of access and display, optionally including the download of additional script.

14. A method as in claim 1, where the activation invokes a web browser, which responds to data in the wrapper by seeking a cross-operating-system runtime and if such a runtime is absent, opening a web page capable of performing the display step as a web service, or of installing the runtime and enabling local performance of a script, or of passing the content to an independent program designed for editing or other modification of files.

15. A method as in claim 1, where the content data of the digital file constitute a document, a geometric or mechanical design, a spreadsheet, a music file, a video file, a mixed-media file, a musical score, source code for a computer program, executable mathematical symbolism, or a game state.

16. A method as in claim 1, where a record is kept of events belonging to one or more of the classes: version creation, with timestamps and data as to previous versions drawn upon; version transmissions; version receptions, version openings.

17. A method as in claim 1, where an automatic local or remote saving is on a continuous or highly frequent basis whenever the user is editing and connected to the server.

18. A method as in claim 1, where the most recent version is presented to the user in mailing or other sharing interactions under the general name of the collaboration, sparing the user any nomenclature of version control.

19. A method as in claim 1, where the Wrapper includes a key that the external system will not accept more than once, and without which the external system withholds remote opening or decryption of the file or a key required for local opening or decryption of the file, as appropriate.

20. A method in a first communication device for distributed coordination of access to digital files, comprising the steps of:
making a version of a file applying wrapper data to the version;
indicating with an indicator the version as being a version with wrapper data; and
sending the version file to a second communication device.

21. A method in a second communication device for distributed coordination of access to digital files, comprising the steps of:
receiving a version file at a receiver arrangement of the second communication device;
reading the indicator of the version file;
initiating an application to read the wrapper data;
using the wrapper data in the second communication device to access the version, related versions and/or collation data of different versions of the file, in a local or other store that contains records relating to other files with the CollaborationID found in the wrapper; and
displaying the version, related versions and/or collation data of different versions of the file.

22. A first communication device for distributed coordination of access to digital files comprising
a processor arranged to create a version of a file, to apply wrapper data to the version and to indicating with an indicator the version as being a version with wrapper data; and
a transmission arrangement configured to send the version file to a second communication device.

23. A second communication device for distributed coordination of access to digital files comprising
a receiving arrangement configured to receive a version file;
a processor arranged to read an indicator of the version file, to initiate an application to read the wrapper data, and to use the wrapper data in the second communication device to access the version, related versions and/or collation data of different versions of the file, in a local or other store that contains records relating to other files with the CollaborationID found in the wrapper; and
a display arrangement configured to display the version, related versions and/or collation data of different versions of the file.
